(19) United States
(12) Patent Application Publication
(10) Pub. No.: US 2007/0083673 A1
(43) Pub. Date: Apr. 12, 2007

(54) Hypertext content filter

(75) Inventors: Marcos R. Lara, New York, NY (US); Shant Hovnanian, New York, NY (US)

Correspondence Address: SYNNESTVEDT LECHNER & WOODBRIDGE LLP, P O BOX 592, 112 NASSAU STREET, PRINCETON, NJ, 08542-0592, US

(73) Assignee: Speedus Corp., New York, NY (US)

(21) Appl. No.: 11/245,830

(22) Filed: Oct. 7, 2005

(51) Int. Cl. G06F 15/16

(52) U.S. Cl. 709/246

(57) ABSTRACT

A system and method for providing fine grain, geographical targeting of content to wireless network users that are using a network in which each wireless access point has an associated location identity. Mobile device are assigned the same location identity as their wireless access point for the duration of the access. When the connected device downloads content from an ad-server, the ad-sever may then use that location to download location targeted content. The location targeted content may be substituted for more generic content.

### FIELD OF THE INVENTION

The present invention relates to systems and methods for content presentation using content elements obtained over a network, and particularly to systems and methods for inserting content elements having a local significance into content presentations.

### BACKGROUND OF THE INVENTION

Content presentations as performed by, for instance, web browsers displaying hypertext markup pages, typically include obtaining display elements, such as images, from network addressable locations that are typically remote from both the client running the web browser and the server delivering the hypertext markup presentation.

This ability to include display elements from different network locations into a hypertext markup presentation is used in the field of display advertising to provide centralized advertising servers that can deliver advertising to multiple publishers.

The central servers supplying the advertisements, known as ad-servers, may supply different advertisements to each of the web browsers or clients requesting an advertisement. Most ad-servers do not, however, have any means for geographically differentiating the requests from clients, except by parsing the request to obtain a country code of a domain. Many advertisers would like to target users with a geographical granularity that is significantly finer than a country and would be particularly interested in a system capable of delivering different advertising to a client depending on the client's current geographical location at a granularity as fine as the street location, or even the house or building number within the street.

### SUMMARY OF THE INVENTION

Briefly described, the present invention provides a system and method for providing fine grain, geographical targeting of content to wireless network users.

In a preferred embodiment of the present invention, each wireless access point in a network may have an associated location identity that may be, but is not limited to, a geographic latitude and longitude. When a mobile wireless device connects to a network wireless access point, that wireless device may be assigned the same location identity as the wireless access point for the duration of the access. When the connected wireless device downloads content from an ad-server, the ad-sever may then use the current location of the wireless device to download advertising content targeted to that current location to that wireless device.

In a further preferred embodiment, the targeted advertising may be substituted for more generic advertising. For instance, if the content down loaded by the wireless device is a hypertext markup language (HTML) document, a content manager module running on the wireless device may parse the HTML. Whenever the HTML indicates an advertising insert, the content manager may substitute a local advertising insert. This may be done by, for instance, recognizing a universal resource locator (URL) indicative of a request for advertising content elements from an ad-server. The content manager may then, for instance, insert the current location of the mobile wireless device into the request for advertising content elements in such a way that the ad-server may deliver a geographically targeted advertisement having a fine geographic granularity.

In another preferred embodiment, the content manager may substitute the URL of another ad-server for the first, and add the current location of the mobile device to the request. In this embodiment, the ad-server that serves the location target advertising content may be remote from, and unrelated to the ad-server originally designated to provide the advertising material.

These and other features of the invention will be more fully understood by references to the following drawings.

### BRIEF DESCRIPTION OF THE DRAWINGS

FIG. 1 is a schematic drawing of a prior art system used for advertising.

FIG. 2 is a flow diagram outlining steps of a prior art method used for advertising.

FIG. 3 is a schematic drawing of a local proxy embodiment of the present invention.

FIG. 4 is a flow chart outlining steps of a local proxy method of the present invention.

FIG. 5 is a schematic drawing of a remote proxy embodiment of the present invention.

FIG. 6 is a flow chart outlining steps of a remote proxy embodiment of the present invention.

FIG. 7 is a schematic drawing of a remote proxy having a virtual private network embodiment of the present invention.

FIG. 8 is a flow chart outlining steps of a remote proxy having a virtual private network method of the present invention.

### DETAILED DESCRIPTION

The present invention provides a system and method for fine grain, geographically targeted delivery of content by selectively replacing content elements in a document display, dependent on a location of the client requesting the content. The system and methods of this invention are of particular interest to the advertising community.

In a preferred embodiment, the geographic location of a user accessing a network via an access point may be inferred from the known, geographic location of the access point. In particular, the location of a mobile wireless device may be inferred from the geographical location of the wireless access point being used.

The geographical location of the wireless access point may be known in a number of ways including, but not limited to, Global Positioning Satellite (GPS) information, a street address, or a postal code such as the nine digit ZIP-plus-four zip code. The geographical information may be provided by the owner of the wireless access point when registering the access point. This registration may, for instance, be part of the process of becoming a member of a network community. Members of such a network community may, for instance, share secure access to the network via each other's wireless networks, based on some pre-agreed community rules.

If the location information is provided in the form of the ZIP-plus-four zip code, it may be converted into a latitude and longitude representative of the geographical location of the wireless access point to within a few tens of meters. Any mobile wireless device connected via that access point may then be inferred to have the same geographical location within the error of the range of the wireless protocol being used. For devices using the well-known WiFi communications protocol, that range may be of the order of 30 meters.

A location identification with this fine a granularity may allow advertisers to target customers based on the street they are currently on, or the particular building they are currently in. For instance by inferring the user's current proximity to a business, advertising relevant to that business may be delivered while the customer is in the vicinity. Moreover, that location information may be linked to the user's current activities by monitoring the content the user is accessing, or has recently accessed.

A preferred embodiment of the invention will now be described in more detail by reference to the accompanying drawings in which, as far as possible, like numbers represent like elements.

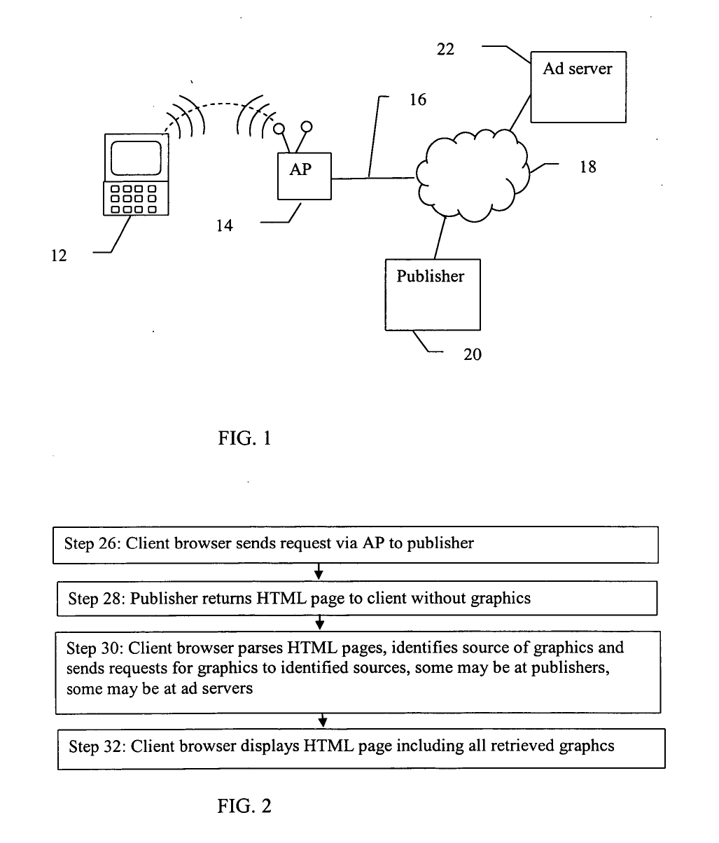

FIG. 1 is a schematic drawing of a prior art system used for advertising. The system comprises a wireless device 12, a wireless access point 14, a wired link 16, a data network 18, a publisher of content 20, and an ad server 22.

The wireless device 12 may be any suitable device for obtaining and displaying content such as, but not limited to, a wirelessly equipped laptop computer, a personal digital assistant or a mobile phone. The wireless device may include, but is not limited to, a web-browser capable of parsing and displaying content such as, but not limited to, a hyper text markup language (HTML) document. Such browsers are typically capable of displaying multimedia content in a variety of forms including, but not limited to, audio in wav files and graphics in pdf, gif, tiff and Flash formats.

The wireless access point 14 may be capable of providing wireless communications via a protocol such as, but not limited to, the various versions of the Institute of Electrical and Electronics Engineers (IEEE) wireless local area network (WLAN) know as the IEEE 802.11 or WiFi protocols.

The link 18 between the wireless access point 14 and the network 18 may be, but is not limited to, a cable high-speed line including a modem, a telephone line with appropriate modem or a fiber optic link. The network 18 may be any suitable data network including, but not limited to the Internet.

The publisher 20 may be any suitable provider of content such as, but not limited to a web-server delivering content in the form of an HTML page, including any necessary multimedia sound, video and image files, or the location of such files in the form of uniform resource locations (URLs).

The ad-server 22 may be any suitable server delivering advertising material in the form of multimedia files such as suitably formatted sound, image or video files.

FIG. 2 is a flow diagram outlining steps used by the system of FIG. 1 for delivering advertising to a client.

In step 26, a client-browser software module running on the mobile wireless device 12 sends a request via the wireless access point 14 to the publisher 20. The request may, for instance, take the form of a uniform resource locator (URL) requesting a document in the form of an HTML page.

In step 28, the publisher 20 may respond to the request by sending the required HTML page to the web browser running on the mobile wireless device 12. The HTML page is typically comprised of ASCII characters, and does not contain any actual multimedia elements, such as the images, video or audio, that may form part of the final document when displayed. The HTML page does, however, typically contain details of any required multimedia elements such as the size of the image to be displayed, the location of a file containing the image to be displayed in the form of a URL and the format in which the image has been encoded in that file.

In step 30, the web browser parses the HTML page and identifies, for instance, what graphics are required. The browser then sends requests to the URL's associated with the image to retrieve the image files. The image files may be located on the publishers web site 20 or they may be located at a third party web site.

In the field of advertising, the use of third party ad-server 22, websites is common. This allows a number of publishers to concentrate on providing content of interest. The ad-sever owner may then focus on selling advertising and may display that advertising over more than one publication, with the advertiser and publisher dividing revenue between them based on, for instance, the number of ad requests generated by the publisher's content pages being viewed.

In step 32, the client browser displays the HTML page, including the multimedia elements, such as images, gathered from the publisher's website 20 and the advertising multimedia elements, such as images, gathered from the ad-server 22.

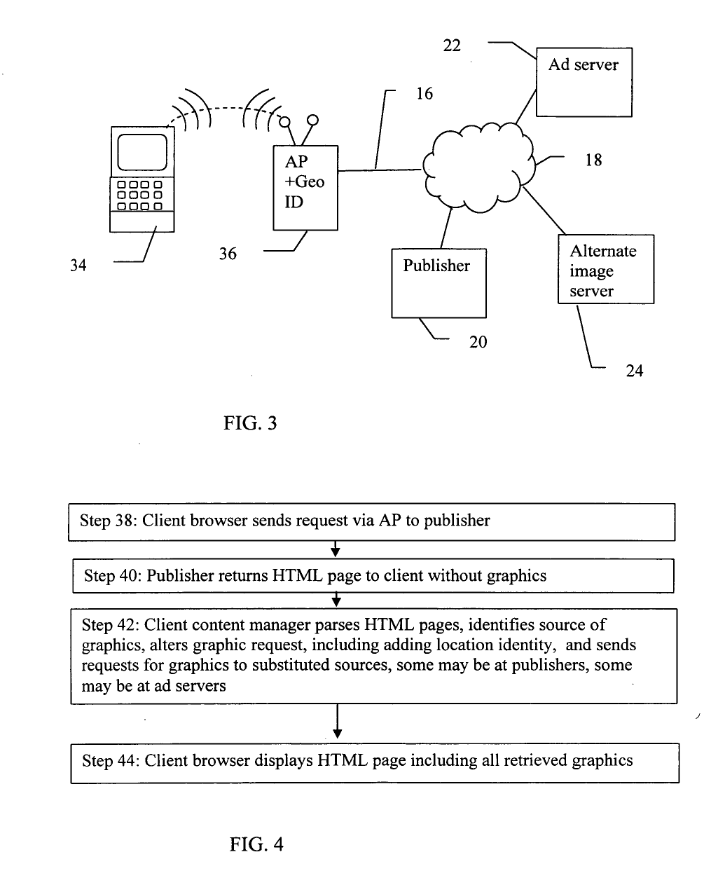

FIG. 3 is a schematic drawing of a local proxy embodiment of the present invention. The wireless mobile device 34 is similar to the mobile wireless device 12 but now includes a content manager that may be a software module capable of parsing HTML documents and having databases of well-known ad-servers as well as the URL of one or more alternate, location-targeted content servers 24.

The wireless access point 36 is similar to the wireless access point 14, but now include a geographic or location identification. The geographical location of the wireless access point may be known in a number of ways including, but not limited to, Global Positioning Satellite (GPS) information, a street address, or a postal code such as the nine digit ZIP-plus-four zip code. The geographical information may be provided by the owner of the wireless access point when registering the access point. This registration may, for instance, be part of the process of becoming a member of a network community. Members of such a network community may, for instance, share secure access to the network via each other's wireless networks, based on some pre-agreed community rules.

If the location information is provided in the form of the ZIP-plus-four zip code, it may be converted into a latitude and longitude representative of the geographical location of the wireless access point to within a few tens of meters. Any mobile wireless device connected via that access point may then be inferred to have the same geographical location within the error of the range of the wireless protocol being used. For devices using the well-known WiFi communications protocol, that range may be of the order of 30 meters.

The alternate, location-targeted content servers 24 may be an ad-server similar to the ad-server 22, but may be operated by a third party. The alternate, location-targeted content servers 24 may include location specific content files, such as audio, image or video files, to be delivered responsive to the location identification of the client requesting the files, or the location identification of the access point via which the client is requesting the files.

FIG. 4 is a flow chart outlining steps of a local proxy method of the present invention.

In step 38, a client browser running on the wireless device 34 sends a request for an HTML page via the access point 36 to the publisher 20.

In step 40, the publisher returns the HTML page to the client browser on the wireless device 34. The HTML page is a series of ASCII characters with no actual multimedia files, but does contain information relating to any required multimedia files such as, but not limited to, a URL from which the file may be downloaded and the format of the file.

In step 42, prior to the client browser displaying the HTML page, a content manager software module running on the wireless device 34 parses the HTML page. The content manager software module may identifies the source of any requests for graphics, and identify, for instance, those requests for image files that are deemed to be advertising. This may be done by, for instance, consulting a database, resident on the wireless device 34, that contains a list of known ad-server URLs. The content manager may then alter any such requests for advertising. This alteration may take the form of adding location identity to the request, or it may take the form of altering the requested URL and adding location identity. The location identity may be obtained by the content manager software module from the access point 36 at any time during the access. The altered URL may also be taken from a database of known location-targeted content servers 24 resident on the wireless device 34. Both the database of known ad-servers and the database of known location-targeted content servers may be updated from time to time by reference to a website or by information pushed from a website.

Once a pre-selected fraction of the advertising image requests have been altered by the content manager software module, the multimedia element requests are sent via the access point 36 to the appropriate serves, which may be the publisher 20, the ad server 22, in the event that not all advertising request are altered, and the alternate, location-targeted content servers 24.

In step 44, after receiving all the requesting multimedia elements, including the substituted local advertising multimedia element files from the alternate, location-targeted content servers 24, the client browser decodes and displays the HTML page, including all the content obtained from the retrieved multimedia element files.

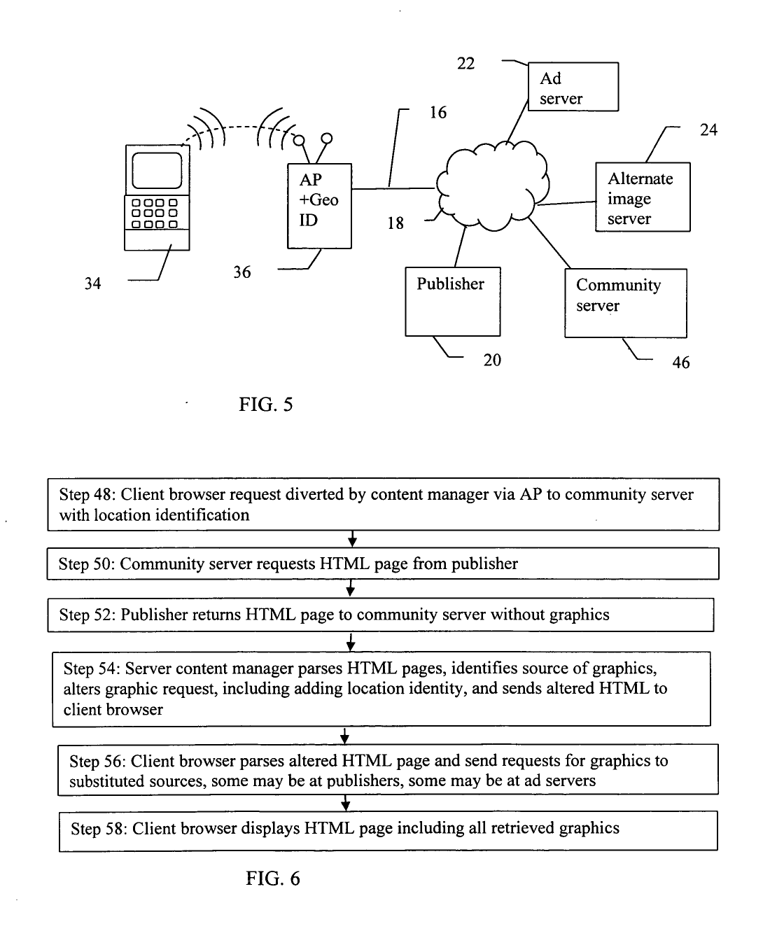

FIG. 5 is a schematic drawing of a remote proxy embodiment of the present invention.

The system of FIG. 5 has the additional community server 46. This may be a server hosting a website that provides services to a member of a community. The community server may also run server content manager software and have databases of known ad-servers and alternate, location-targeted content servers.

FIG. 6 is a flow chart outlining steps of a remote proxy embodiment of the present invention, shown schematically in FIG. 5.

In step 48, a request for an HTML page from a particular publisher 20 by a client browser running on wireless device 34 is diverted by a content manager software module, also running on the wireless device 34, to the community server 46. The diversion may take the form of encapsulating the request in a packet addressed to the community server.

In step 50, the community server 46 receives the diverted request. The community server then process the diverted request and sends a request for the required HTML page from the particular publisher 20, to the publisher, but to have the page returned to the community server 46.

In step 52, the publisher 20 returns the required HTML page to the community server. As before, this HTML page is a series of ASCII characters with no actual multimedia files, but does contain information relating to any required multimedia files such as, but not limited to, a URL from which the file may be downloaded and the format of the file.

In step 54, a content manager software module running on the community server 46 parses the HTML page. The server content manager software module may identify the source of any requests for graphics, and separate out, for instance, those requests for image files that are deemed to be advertising requests. This separation may be done by, for instance, consulting a database, resident on the community server 46, that contains a list of known ad-server URLs. The server content manager may then alter any such requests for advertising. This alteration may take the form of adding location identity to the request, or it may take the form of altering the requested URL and adding location identity. The location identity may be obtained by the server content manager software module from the access point 36 at any time during the access. The altered URL may also be taken from a database of known location-targeted content servers 24 resident on the community server 46. Both the database of known ad-servers and the database of known location-targeted content servers may be updated from time to time.

Once a pre-selected fraction of the advertising image requests have been altered by the server content manager software module, the altered HTML page is sent to the wireless device 34.

In step 56, the client content manager or a web browser running on the wireless device 34, parse the altered HTML page and send the altered multimedia element requests to the appropriate serves, which may be the publisher 20, the ad server 22, in the event that not all advertising request are altered, and the alternate, location-targeted content servers 24.

In step 58, once the request for content have been responded to, the client browser decodes and displays the HTML page, including all the content obtained from the retrieved multimedia element files.

The embodiment of the invention outlined in the steps of FIG. 6 has the advantage that the database containing lists of ad-severs to be substituted and the database containing the list of alternate, location-targeted content servers 24 both reside on the community server. Updating these databases is simple as they are in one location and only require one update. In contrast, in the embodiment of the invention outlined in FIG. 4, the equivalent databases reside on the wireless devices 34. If the databases are to be updated, information has to be sent to all the wireless devices 34 that are part of the community, requiring considerably more effort and posing considerably more obstacles to keeping all the databases synchronized.

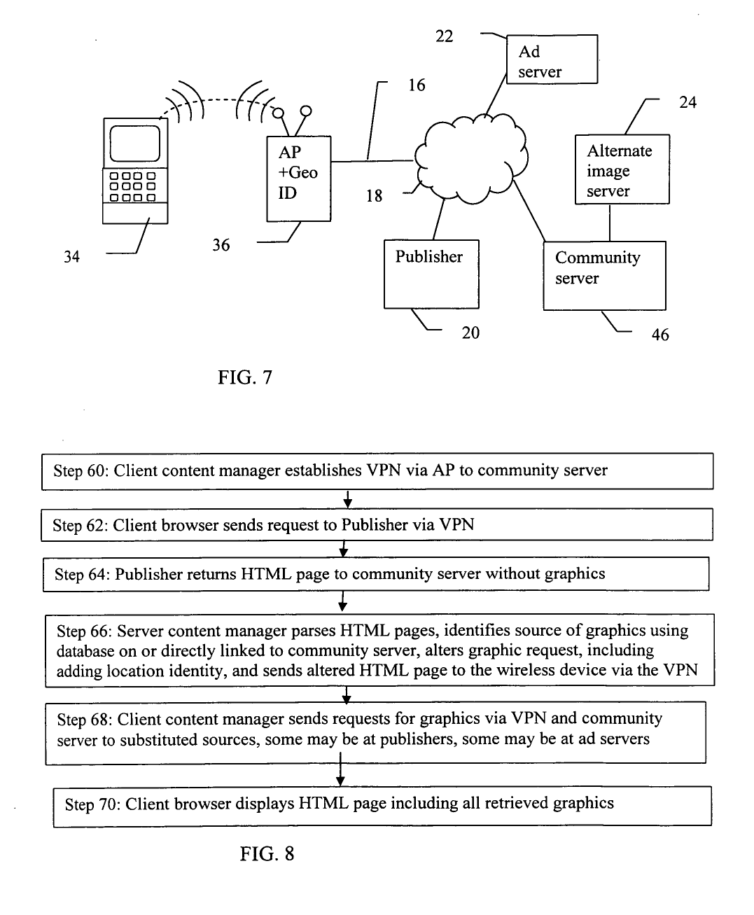

FIG. 7 is a schematic drawing of a remote proxy having a virtual private network embodiment of the present invention. The elements of FIG. 7 are the same as those of FIG. 5, with one difference: alternate, location-targeted content server 24 is now accessed by the community server 24 via a private network rather than the public network 18.

FIG. 8 is a flow chart outlining steps of a remote proxy having a virtual private network method of the present invention.

In step 60, a client content manager running on the wireless device 34 establishes a virtual private network (VPN) to the community server 46 via the access point 36. This VPN may be implemented by, for instance, well-known techniques such as data tunneling. Data tunneling, also known as “port forwarding,” is generally done by encrypting and encapsulating the data to be transmitted and any necessary protocol information within public network 18 transmission units so that the information appears to the public network as ordinary data. As long as the client content manager and the community server have the necessary decryption and encryption keys, they can exchange data securely even though the data is transmitted over the public network 18.

In step 62, the client browser sends a request for an HTML page to a specific publisher via the VPN and the community server 46.

In step 64, the publisher returns the HTML page to the community server without the graphics.

In step 66, a server content manager, running on the community server 46, parses the HTML and identifies requests for multimedia content elements that are advertising. This identification may involve querying appropriate databases located on the community server 46 or linked to the community server via a private local or wide area network (LAN or WAN). The server content manager may then alter the advertising content element requests in the HTML page by adding the location identification of the access point 36 via which the mobile device 34 is accessing the public network 18. In a further embodiment of the invention, the alteration may include substituting a URL for the advertising media content elements. This substituted URL may point to an alternate, location-targeted content server 24 that is part of the community server 46 or linked to the community server 46 by a private LAN or a private WAN. The server content manager then sends the altered HTML page on to the mobile wireless device 34.

In step 68, a web browser of client content manager running on the mobile wireless device 34 parses the altered HTML page and may send requests for multi-media content via the VPN to the publisher 20, the ad-server 22 and the alternate, location-targeted content server 24 that is part of the community server 46 or linked to the community server 46 by a private LAN or a private WAN.

In step 70, the web browser running on the mobile wireless device 34 receives the requested multi-media content elements via the VPN, and displays the HTML document including all the multi-media content elements.

Although the methods and systems above have been described using a wireless mobile device, one of ordinary skill in the art would appreciate that such systems may be implemented on networks that include access from devices connected by any means, including wired connections as long as the location of the device is known by some means such as, but not limited to, GPS data.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method of replacing content, said method comprising the steps of:
providing a wireless device;
providing a wireless access point having an identified location;
wirelessly connecting said wireless device to a network via said wireless access point;
downloading a hypertext markup language document to said wireless device;
locating a first universal resource locator, indicative of a first image, in said hypertext markup language document; and
substituting, responsive to said identified location, a second universal resource locator, indicative of a second image for said first universal resource locator.

2. The method of claim 1 wherein said identified location comprises providing a geographic latitude and longitude locating said access point to within 100 meters.

3. The method of claim 2 wherein providing said geographic latitude and longitude further comprises providing a ZIP+4 postal address associated with said wireless access point and comparing said ZIP+4 postal address with a position-to-zip database.

4. The method of claim 1 further comprising displaying said hypertext markup document using a browser and wherein said displayed document comprises said second image downloaded using said second universal resource locator.

5. The method of claim 4 wherein said wireless access point is a WiFi access point.

6. The method of claim 1 wherein said locating a first universal resource locator, indicative of a first image comprises running a content manager module on wireless device.

7. The method of claim 6 wherein said content manager references a local database, located on said wireless device, said local database comprising a first list of universal resource locators to be replaced, and a second list of universal resource locators to be substituted for said replaced universal resource locators.

8. The method of claim 6 wherein said content manager references a remote database, located a remote server, said remote database comprising a first list of universal resource locators to be replaced, and a second list of universal resource locators to be substituted for said replaced universal resource locators.

9. The method of claim 1 wherein said locating a first universal resource locator, indicative of a first image comprises running a content manager module on a remote server, and wherein said content manager references a replace database, located on said remote server, said replace database comprising a first list of universal resource locators to be replaced and a second list of universal resource locators to be substituted for said replaced universal resource locators.

10. A system of replacing content, said comprising:
a wireless access point having an identified location;
a wireless device wirelessly connected to a network via said wireless access point;
a hypertext markup language document downloaded to said wireless device;
a first universal resource locator, indicative of a first image, located in said hypertext markup language document; and
a second universal resource locator, indicative of a second image substituted for said first universal resource locator in said hypertext markup language document.

11. The system of claim 10 wherein said identified location comprises a geographic latitude and longitude that locates said access point to within 100 meters.

12. The system of claim 11 wherein said identified location further comprises a ZIP+4 postal address associated with said wireless access point.

13. The system of claim 10 further comprising a browser for displaying said hypertext markup document, and wherein said displayed document comprises said second image downloaded using said second universal resource locator.

14. The method of claim 13 wherein said wireless access point is a WiFi access point.

15. The system of claim 10 wherein said first universal resource locator, indicative of a first image is located by a content manager module running on said wireless device.

16. The system of claim 15 wherein said content manager references a local database, located on said wireless device, said local database comprising a first list of universal resource locators to be replaced, and a second list of universal resource locators to be substituted for said replaced universal resource locators.

17. The method of claim 15 wherein said content manager references a remote database, located a remote server, said remote database comprising a first list of universal resource locators to be replaced, and a second list of universal resource locators to be substituted for said replaced universal resource locators.

18. The method of claim 10 wherein said first universal resource locator, indicative of a first image is located by a content manager module running on a remote server, and wherein said content manager references a replace database, located on said remote server, said replace database comprising a first list of universal resource locators to be replaced and a second list of universal resource locators to be substituted for said replaced universal resource locators.
